(19) United States
(12) Patent Application Publication
(10) Pub. No.: US 2026/0214476 A1
(43) Pub. Date: Jul. 23, 2026

(54) TERMINAL AND RADIO COMMUNICATION METHOD

(71) Applicant: NTT DOCOMO, INC., Tokyo (JP)

(72) Inventors: Hidekazu SHIMODAIRA, Tokyo (JP); Hiroki YAMADA, Tokyo (JP); Yuki MATSUMURA, Tokyo (JP)

(73) Assignee: NTT DOCOMO, INC., Tokyo (JP)

(21) Appl. No.: 19/100,940

(22) PCT Filed: Aug. 9, 2022
(86) PCT No.: PCT/JP2022/030499

§ 371 Date: Feb. 4, 2025

(51) Int. Cl. H04W 24/08

(52) U.S. Cl. CPC H04W 24/08

(57) ABSTRACT

A terminal simultaneously receives a synchronization signal block or a reference signal using multiple reception chains, and when receiving the synchronization signal block or the reference signal using the multiple reception chains in a second frequency range that is a higher frequency band than a first frequency range, the terminal reduces the number of samples used for measurement in the second frequency range compared to receiving the synchronization signal block or the reference signal using a single reception chain.

### TECHNICAL FIELD

The present disclosure relates to a terminal and a radio communication method that support the expansion of radio resource management.

### BACKGROUND

The 3rd Generation Partnership Project (3GPP; Registered Trademark) has prepared a specification for the 5th generation mobile communication system (which may be called 5G, New Radio (NR), or Next Generation (NG)), and is also in the process of specifying the next generation called Beyond 5G, 5G Evolution, or 6G.

In 3GPP Release 18, regarding radio resource management (RRM), the expansion of simultaneous reception using multiple reception chains (RX chains) in FR2 (frequency range 2) will be discussed (for example, NON-PATENT LITERATURE 1).

In Release up to 3GPP Release 17, the provisions regarding FR2 are based on the assumption that the simultaneous reception of multiple beams is not possible, and simultaneous measurement of RLM (Radio Link Monitoring), RRM and MG (Measurement Gap) is not possible. Therefore, consideration has been given to dealing with such restrictions in such FR2 by applying scaling factors to various provisions regarding RRM or the like.

### CITATION LIST

### Non-Patent Literature

NON-PATENT 1: “Requirement for NR LITERATURE frequency range 2 (FR2) multi-Rx chain DL reception”, RP-221753, 3GPP TSG RAN Meeting #96, 3GPP, June 2022

### SUMMARY OF THE INVENTION

However, in the case of FR2, a problem is that a relatively long time is required for measurement performed by a terminal (User Equipment, UE) due to the application of the scaling factors described above.

Therefore, the present disclosure has been made to solve the above problem, and an object of the present invention is to provide to provide a terminal and a radio communication method capable of performing an operation related to a faster measurement even when using a high frequency band such as FR2.

An aspect of the present disclosure is a terminal (UE 200) including: a reception unit (control signal and reference signal processing unit 240) that simultaneously receives a synchronization signal block or a reference signal using multiple reception chains; and a control unit (control unit 270) that, when receiving the synchronization signal block or the reference signal using the multiple reception chains in a second frequency range that is a higher frequency band than a first frequency range, reduces a number of samples used for measurement in the second frequency range compared to receiving the synchronization signal block or the reference signal using a single reception chain.

An aspect of the present disclosure is a terminal (UE 200) including; a reception unit (control signal and reference signal processing unit 240) that simultaneously receives a synchronization signal block or a reference signal using multiple reception chains; and a control unit (control unit 270) that, when receiving the synchronization signal block or the reference signal using the multiple reception chains in a second frequency range that is a higher frequency band than a first frequency range, applies a common transmission configuration indication to the multiple reception chains.

An aspect of the present disclosure is a terminal (UE 200) including: a reception unit (control signal and reference signal processing unit 240) that simultaneously receives a synchronization signal block or a reference signal using multiple reception chains; and a control unit (control unit 270) that, when receiving the synchronization signal block or the reference signal using the multiple reception chains in a second frequency range that is a higher frequency band than a first frequency range, applies an individual transmission configuration indication to each of the multiple reception chains.

An aspect of the present disclosure is a radio communication method including: a step of simultaneously receiving a synchronization signal block or a reference signal using multiple reception chains; and a step of reducing, when receiving the synchronization signal block or the reference signal using the multiple reception chains in a second frequency range that is a higher frequency band than a first frequency range, a number of samples used for measurement n the second frequency range compared to receiving the synchronization signal block or the reference signal using a single reception chain.

### BRIEF DESCRIPTION OF DRAWINGS

FIG. 1 is an overall schematic diagram of a radio communication system 10.

FIG. 2 is a diagram illustrating the frequency ranges used in the radio communication system 10.

FIG. 3 is a diagram illustrating a configuration example of radio frames, sub-frames, and slots used in the radio communication system 10.

FIG. 4 is a functional block diagram of gNB 100 and UE 200.

FIG. 5 is a diagram illustrating a configuration example of SSB, SMTC, and MG according to operation example 1-1.

FIG. 6 is a diagram illustrating a configuration example of SSB, SMTC, and MG according to operation example 1-2.

FIG. 7 is a diagram illustrating a configuration example of SSB, SMTC, and MG according to operation example 1-3.

FIG. 8 is a diagram illustrating a configuration example of SSB, SMTC, and MG according to operation example 1-4.

FIG. 9 is a diagram illustrating a configuration example of SSB, SMTC, and MG according to operation example 1-5.

FIG. 10 is a diagram illustrating a configuration example of SSB, SMTC, and MG according to operation example 1-6.

FIG. 11 is a diagram illustrating a configuration of an evaluation time (T_{Evaluate_CBD_SSB}/T_{Evaluate_CBD_CSI-RS}) to which a scaling factor PTRP is referred.

FIG. 12 is a diagram illustrating an example of a hardware configuration of the gNB 100 and the UE 200.

FIG. 13 is a diagram illustrating a configuration example of a vehicle 2001.

### DETAILED DESCRIPTION OF THE INVENTION

An embodiment will be described below with reference to the drawings. Note that the same or similar reference numerals have been attached to the same functions and configurations, and a description thereof will be omitted as appropriate.

### (1) Overall Schematic Configuration of Radio Communication System

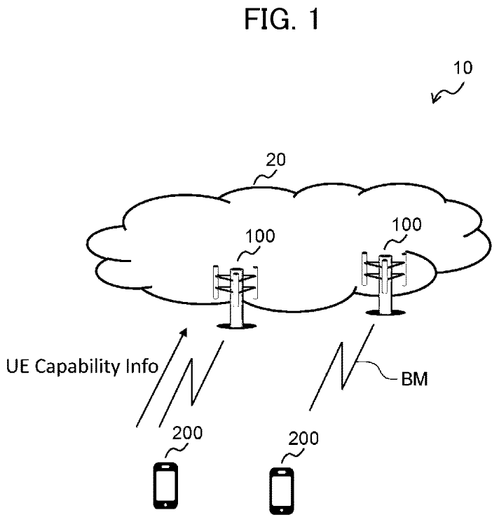

FIG. 1 is an overall schematic diagram of a radio communication system 10 according to the present embodiment. The radio communication system 10 is a radio communication system according to 5G New Radio (NR), and includes a Next Generation-Radio Access Network 20 (hereinafter, referred to as NG-RAN 20) and a terminal 200 (hereinafter, referred to as User Equipment (UE) 200). The radio communication system 10 may be a radio communication system according to a scheme called Beyond 5G, 5G Evolution, or 6G.

The NG-RAN 20 includes a radio base station 100 (gNB 100). The specific configuration of the radio communication system 10 including the number of gNBs and UEs is not limited to the example illustrated in FIG. 1.

The NG-RAN 20 actually includes a plurality of NG-RAN nodes, specifically gNBs (or ng-eNBs), and is connected to a core network (5GC, not illustrated) according to 5G. The NG-RAN 20 and 5GC may be simply referred to as a network.

The gNB 100 is a radio base station according to 5G, and performs radio communication with the UE 200 according to 5G. The gNB 100 and the UE 200 can support Massive MIMO (Multiple-Input Multiple-Output) that generates a beam BM with higher directivity by controlling radio signals transmitted from a plurality of antenna elements, carrier aggregation (CA) that uses a plurality of component carriers (CCs) bundled together, dual connectivity (DC) that simultaneously performs communication between the UE and each of the two NG-RAN nodes, and the like.

A type of DC may be Multi-RAT Dual Connectivity (MR-DC) that uses multiple radio access technologies, or NR-NR Dual Connectivity (NR-DC) that uses only NR. The MR-DC may be E-UTRA-NR Dual Connectivity (EN-DC) in which the eNB constitutes a master node (MN) and the gNB constitutes a secondary node (SN), or NR-E-UTRA Dual Connectivity (NE-DC) having the reverse configuration.

Any gNB 100 may constitute a master node (MN), and the other gNB 100 may constitute a secondary node (SN).

In DC, a master cell group (MCG) and a secondary cell group (SCG) may be configured. The MCG may include a primary cell (PCell), and the SCG may include a secondary cell (SCell).

The SCell may include a primary secondary cell (PSCell). The PSCell is a type of SCell, but may be interpreted as a special SCell having the same functions as the PCell. Similar to the PCell, the PSCell may perform a PUCCH (Physical Uplink Control Channel) transmission, a contention-type random access procedure (CBRA), a radio link monitoring (downlink radio quality monitoring) function, and the like.

The gNB 100 can spatially and time-divisionally transmit multiple beams BMs with different transmission directions (which may be referred to simply as directions, or radial directions, coverage, etc.). Note that the gNB 100 may transmit multiple beams BMs simultaneously.

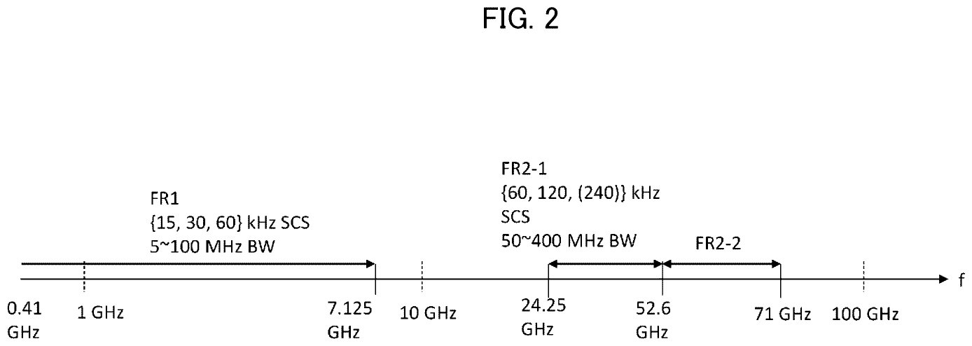

The radio communication system 10 supports a plurality of frequency ranges (FR). FIG. 2 illustrates the frequency ranges used in the radio communication system 10.
FR1: 410 MHz to 7.125 GHz
FR2
   FR2-1:24.25 MHz to 52.6 GHz
   FR2-2: over 52.6 MHz to 71 GHz

In FR1, sub-carrier spacing (SCS) of 15, 30 or 60 KHz may be used, and a bandwidth (BW) of 5 to 100 MHz may be used. FR2 has a higher frequency than FR1, and sub-carrier spacing (SCS) of 60 or 120 kHz (may include 240 kHz) may be used, and a bandwidth (BW) of 50 to 400 MHz may be used.

The SCS may be interpreted as numerology. The numerology is defined in 3GPP TS38.300, and corresponds to one sub-carrier spacing in the frequency domain.

Further, the radio communication system 10 also supports a higher frequency band than that of FR2-2.

When a band exceeding 52.6 GHz is used, Cyclic Prefix-Orthogonal Frequency Division Multiplexing (CP-OFDM)/Discrete Fourier Transform-Spread (DFT-S-OFDM) having larger sub-carrier spacing (SCS) may be applied.

In a higher frequency band such as FR2-2, an increase in phase noise between carriers is a problem as described above. This may require the application of larger (wider) SCS or a single carrier waveform.

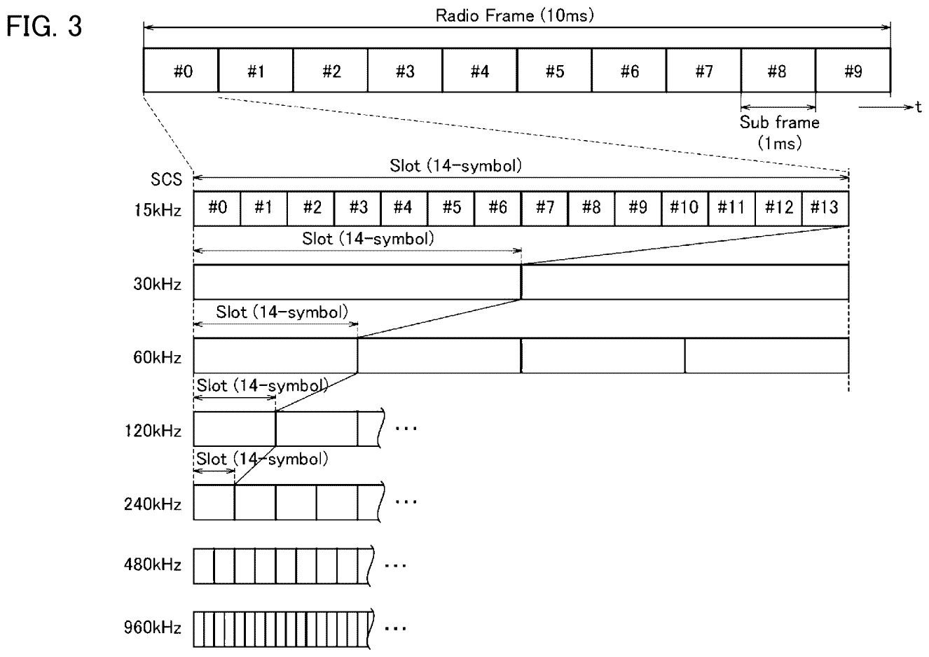

The symbol/CP (cyclic prefix) period and the slot period become shorter (when a configuration of 14 symbols/slots is maintained) as the SCS becomes larger. FIG. 3 illustrates a configuration example of radio frames, subframes and slots used in the radio communication system 10.

When a configuration of 14 symbols/slots is maintained, the symbol period (and the slot period) become shorter as the SCS becomes larger (wider). The symbol period may be referred to as a symbol length, a time direction, a time domain, or the like. The frequency direction may be referred to as a frequency domain, a resource block, a sub-carrier, a BWP (bandwidth part), or the like.

The frequency resources may include component carriers, sub-carriers, resource blocks (RBs), resource block groups (RBGs), BWPs (bandwidth parts), and the like. The time resources may include symbols, slots, minislots, subframes, radio frames, DRX (Discontinuous Reception) periods, and the like.

Note that the number of symbols constituting one slot may not necessarily be 14 symbols (for example, 28 or 56 symbols). Further, the number of slots for each subframe may vary depending on the SCS.

In the radio communication system 10, a synchronization signal block (SSB (SS/PBCH Block)) constituted of a synchronization signal (SS) and a downlink physical broadcast channel (PBCH) may be used.

The SSB is periodically transmitted from the network mainly for the UE 200 to detect a cell ID and reception timing when starting communication. In NR, the SSB is also used to measure the reception quality of each cell. The SSB transmission period (periodicity) may be 5, 10, 20, 40, 80, 160 milliseconds, or the like. Note that the initial access UE 200 may be assumed to have a transmission period of 20 milliseconds.

The radio communication system 10 may also support various operations regarding radio resource management (RRM) specified in 3GPP TS38.133. Specifically, various quality measurements for RRM may be supported. For example, the RRM may include measurements based on SSB and/or Channel State Information-Reference Signal (CSI-RS). Such measurements may be performed in an STMC window according to SSB based RRM Measurement Timing Configuration (SMTC).

The SMTC may indicate the periodicity/duration/offset information of the measurement window for the UE RRM measurements for each carrier frequency.

A measurement interval called MG (Measurement Gap) may also be applied to such measurements. The MG may be configured for each UE, each FR, or the like. The length of the MG (MGL) may be longer than the SMTC window. As the MGL, for example, 1.5, 3, 3.5, 4, 5.5, and 6 ms may be configured.

In addition, the radio communication system 10 may support inter-cell mobility (L1/L2 inter cell mobility) of the UE 200 based on layer 1/layer 2. For example, the UE 200 can transmit and receive uplink (UL)/downlink (DL) channels and/or reference signals with a cell having a PCI (Physical Cell ID) different from a PCI of a serving cell. Therefore, if the RSRP (Reference Signal Received Power) of a non-serving cell is larger than that of the serving cell, the UE 200 can transmit and receive the channels and reference signals with the non-serving cell without performing handover.

### (2) Functional Block Configuration of Radio Communication System

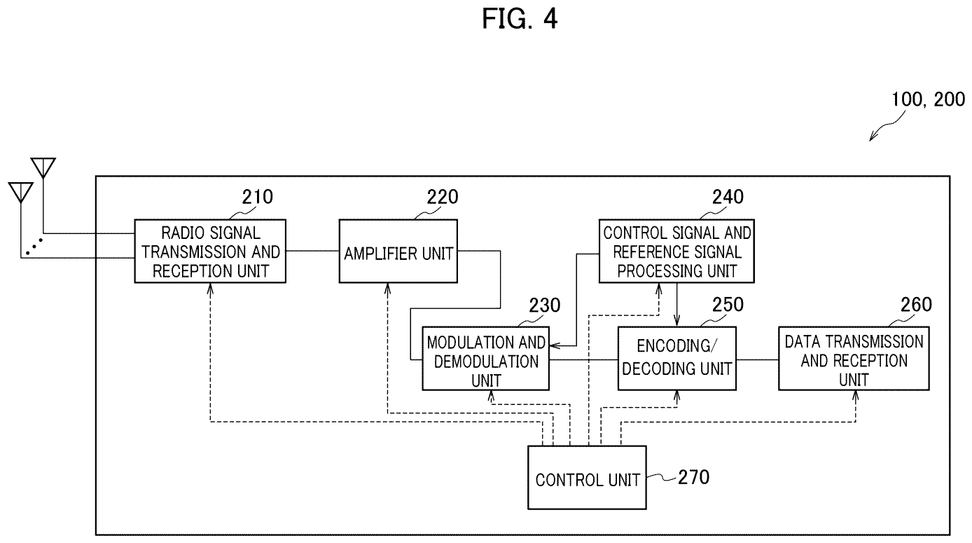

Next, a functional block configuration of the radio communication system 10 will be described. Specifically, a functional block configuration of the UE 200 will be mainly described. FIG. 4 is a functional block diagram of the gNB 100 and the UE 200.

As illustrated in FIG. 4, the UE 200 includes a radio signal transmission and reception unit 210, an amplifier unit 220, a modulation and demodulation unit 230, a control signal and reference signal processing unit 240, an encoding/decoding unit 250, a data transmission and reception unit 260, and a control unit 270.

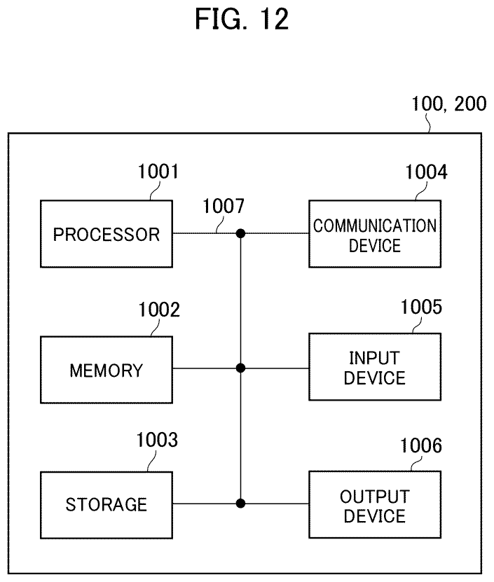

Note that only the main functional blocks related to the description of the embodiment are illustrated in FIG. 4, and the UE 200 (gNB 100) has other functional blocks (for example, a power supply). In addition, FIG. 4 illustrates a functional block configuration of the UE 200, and please refer to FIG. 12 for a hardware configuration.

The radio signal transmission and reception unit 210 transmits and receives radio signals according to NR. By controlling radio (RF) signals transmitted from a plurality of antenna elements, the radio signal transmission and reception unit 210 can support Massive MIMO (Multiple-Input Multiple-Output) that generates a beam BM with higher directivity by controlling radio signals transmitted from a plurality of antenna elements, carrier aggregation (CA) that uses a plurality of component carriers (CCs) bundled together, dual connectivity (DC) that simultaneously performs communication between the UE and each of the two NG-RAN nodes, and the like.

The amplifier unit 220 includes a PA (Power Amplifier)/LNA (LOW Noise Amplifier) and the like. The amplifier unit 220 amplifies signals output from the modulation and demodulation unit 230 to a predetermined power level. The amplifier unit 220 also amplifies RF signals output from the radio signal transmission and reception unit 210.

The modulation and demodulation unit 230 performs data modulation and demodulation, a transmission power configuration, a resource block allocation, and the like for each predetermined communication destination (gNB 100 or the like). Cyclic Prefix-Orthogonal Frequency Division Multiplexing (CP-OFDM)/Discrete Fourier Transform-Spread (DET-S-OFDM) may applied be in the modulation and demodulation unit 230. In addition, DFT-S-OFDM may be used not only for an uplink (UL), but also for a downlink (DL).

Further, the radio signal transmission and reception unit 210, the amplifier unit 220, and the modulation and demodulation unit 230 may have multiple reception chains (Rx chains). Each reception chain may correspond to a different frequency band (band) or a different frequency range (FR), or the same frequency band or the same FR.

The control signal and reference signal processing unit 240 performs processing regarding various control signals transmitted and received by the UE 200, and processing regarding various reference signals transmitted and received by the UE 200.

Specifically, the control signal and reference signal processing unit 240 receives various control signals transmitted from the gNB 100 via a predetermined control channel, for example, the control signals for a radio resource control layer (RRC). The control signal and reference signal processing unit 240 also transmits various control signals to the gNB 100 via a predetermined control channel.

The control signal and reference signal processing unit 240 performs processing using reference signals (RS), such as demodulation reference and phase tracking reference signals (PTRS).

The DMRS is a terminal-specific reference signal (pilot signal) for estimating a fading channel used for data demodulation, known between a base station and the terminal. The PTRS is a terminal-specific reference signal for the purpose of estimating phase noise which becomes a problem in a high frequency band.

Examples of the reference signals may include, in addition to the DMRS and the PTRS, a channel state information-reference signal (CSI-RS), a sounding reference signal (SRS), and a positioning reference signal (PRS) for positional information.

The channels include control channels and data channels. The control channels may include a PDCCH (Physical Downlink Control Channel), a PUCCH (Physical Uplink Control Channel), a RACH (Random Access Channel), Downlink Control Information (DCI) including a Random Access Radio Network Temporary Identifier (RA-RNTI)), a Physical Broadcast Channel (PBCH), and the like.

In addition, the data channels may include a PDSCH (Physical Downlink Shared Channel), a PUSCH (Physical Uplink Shared Channel), and the like. “Data” refers to data transmitted via the data channel.

The control signal and reference signal processing unit 240 may simultaneously receive a synchronization signal block or a reference signal using multiple reception chains (Rx chains). In the present embodiment, the control signal and reference signal processing unit 240 constitutes a reception unit.

For example, the control signal and reference signal processing unit 240 may simultaneously receive an SSB and/or a CSI-RS using multiple Rx chains. The reference signal is typically a CSI-RS, but it may be other downlink reference signals, or it may be interpreted broadly as the one that includes an SSB.

The control signal and reference signal processing unit 240 may transmit the capability information of the UE 200 to the network. In the present embodiment, the control signal and reference signal processing unit 240 can transmit to the gNB 100, the UE capability information on the quality measurement based on the RRM (see FIG. 1).

The encoding/decoding unit 250 performs data division/concatenation, channel coding/decoding, and the like for each predetermined communication destination (gNB 100 or another gNB).

Specifically, the encoding/decoding unit 250 divides the data output from the data transmission and reception unit 260 into predetermined sizes, and performs channel coding on the divided data. The encoding/decoding unit 250 also decodes the data output from the modulation and demodulation unit 230, and concatenates the decoded data.

The data transmission and reception unit 260 transmits and receives a protocol data unit (PDU) and a service data unit (SDU). Specifically, the data transmission and reception unit 260 performs assembly/disassembly of PDU/SDU in a plurality of layers (a media access control layer (MAC), a radio link control layer (RLC), a packet data convergence protocol layer (PDCP) and the like). In addition, the data transmission and reception unit 260 performs error correction and retransmission control of data based on HARQ (Hybrid Automatic Repeat Request).

The control unit 270 controls each functional block constituting the UE 200. In particular, in the present embodiment, the control unit 270 performs control regarding RRM. In the present embodiment, in particular, the control unit 270 performs control regarding RRM in FR2.

For example, when receiving an SSB or a CSI-RS using multiple reception chains (Rx chains) in FR2 that is a higher frequency band than FR1, the control unit 270 may reduce the number of samples used for measurement in FR2 compared to receiving the SSB or the CSI-RS using a single reception chain. In other words, by receiving the SSB or the CSI-RS using multiple reception chains, the control unit 270 may reduce the number of samples of synchronization signal blocks or reference signals used for measurement.

The required number of samples may be specified in the 3GPP specification as a fixed value, or as a value corresponding to the number of reception chains. The number of samples may be determined by the control unit 270, and the information on the determined number of samples may be reported to the network as the UE capability information.

When receiving an SSB or a CSI-RS using multiple reception chains in FR2, the control unit 270 may apply the number of samples specified for FR1. The number of samples specified for FR1 may not necessarily be the same as the number of samples specified for FR1, as long as the number of samples specified for FR1 are close to the number of samples specified for FR1.

Alternatively, the control unit 270 may apply the number of samples corresponding to the number of reception chains. For example, the number of samples may decrease as the number of reception chains increases.

Further, when receiving an SSB or a CSI-RS using multiple reception chains in FR2, the control unit 270 may apply a common transmission configuration indication (TCI) to the multiple reception chains.

For example, when a TCI state is commonly managed using multiple Rx chains, the SNR (Signal to Noise Ratio) measurement method for determining the known condition of the TCI state may be clearly specified. However, the measurement method may be left to the implementation of the UE 200.

Alternatively, when receiving an SSB or a CSI-RS using multiple reception chains in FR2, the control unit 270 may apply an individual TCI to each of the multiple reception chains.

For example, the control unit 270 may operate according to the existing TCI state switching provision for each Rx chain. In addition, the control unit 270 may operate to preferentially use an Rx chain with less delay.

The gNB 100 (control signal and reference signal processing unit 240) may perform configurations such as SMTC and MG, or may receive CSI reports and UE capability information from the UE 200.

### (3) Operation of Radio Communication System

Next, an operation of the radio communication system 10 will be described. Specifically, an operation example related to RRM performed by the UE 200 using multiple reception chains (Rx chains) will be described.

### (3.1) Assumption and Problem

As described above, the UE 200 has multiple reception chains (Rx chains) and can support simultaneous reception of multiple beams BMS, simultaneous measurement of RLM/RRM/MG, and the like.

In 3GPP Release 18, the mitigation of RRM-related provisions in a case in which the UE 200 has multiple Rx chains and uses FR2 will be discussed.

The RRM provisions regarding FR2 up to 3GPP Release 17 are based on the following assumptions.
Multiple beams cannot be received simultaneously
RLM/RRM/MG cannot be measured simultaneously

For this reason, scaling factors have been introduced in various provisions regarding the RAM and the like. If the UE 200 has multiple Rx chains and uses FR2, the provision contents are possibly mitigated in the following items,
L1-RSRP measurement delay (corresponding to operation example 1)
L3 measurement delay (corresponding to operation example 2)
RLM and BFD/CBD (Beam Failure Detection/Candidate Beam Detection) requirements (corresponding to operation example 3)
Scheduling/measurement restrictions (corresponding to operation example 4)
TCI state switching delay with dual TCI (corresponding to operation example 5)

Note that L1 may mean layer 1, and L3 may mean layer 3.

### (3.2) Operation Example 1

Regarding L1-RSRP measurement delay, the required measurement time is specified in 3GPP for each of SSB and CSI-RS based.

Regarding FR2, the problem is that a relatively long time is required due to the following factors.
8 samples are required as the number of SSB measurement samples
ceil (maxNumberRxBeam/N_{res_per_set}) samples are required as the number of CSI-RS measurement samples depending on the conditions
If SMIC and MG overlap in time, the measurement is required alternatingly

In light of such circumstances, the UE 200 may reduce the number of measurement samples by performing simultaneously reception using multiple Rx chains, A specific example of reduction will be described later.

The required number of samples may be specified as a fixed value, or clearly specified in the specification as a value corresponding to the number of Rx chains. In addition, the information on the determined (configured) number of samples may be reported to the network as the UE capability information.

The UE 200 may mitigate a value of the scaling factor P by simultaneously receiving beams BMs or the like using multiple Rx chains. Although a specific example of mitigation will be described later, an CSI-RS can be similarly mitigated by reading an SSB period as a CSI-RS period. Further, similar mitigation measures may be applied to the provision of L1-SINR (Signal-to-Interference plus Noise power Ratio) measurement and/or the provision of L1-RSRP measurements for a cell with different PCI from serving cell.

In this case, a scaling factor Poor applied when an SSB occasion overlaps between serving cells and non-serving cells may always be 1, or a determined value of the scaling factor may be reported to the network as the UE capability information.

### (3.2.1) Operation Example 1-1

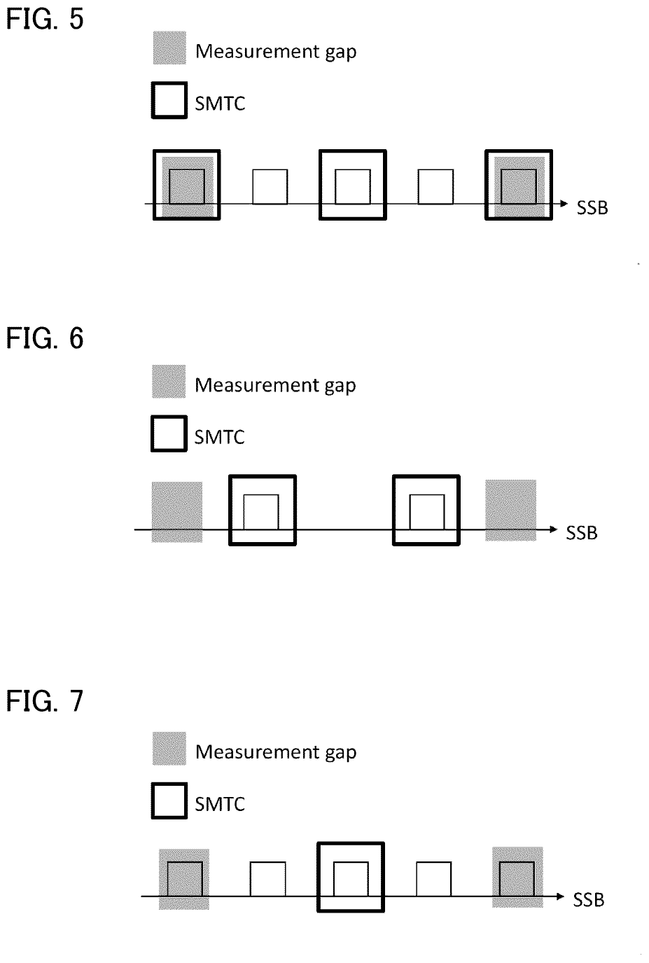

FIG. 5 illustrates a configuration example of SSB, SMTC, and MG according to operation example 1-1. The scaling factor P is specified in 3GPP as follows: (see TS38.133 Sec. 5.4.1/9.5.4.2; the same will be applied hereinafter)

$$\text{?} \qquad [ Math . 1 ]$$

$$\text{?} \text{indicates text missing or illegible when filed}$$

Here, in the case of the configuration of SSB, SMTC and MG illustrated in the above provision (as illustrated in FIG. 5 as an example), it may be the same as the provision in which the SSB is partially overlapped with the MG in FR1. The scaling factor P_{sc} may always be 1. The mitigated value may be reported as the UE capability information.

### (3.2.2) Operation Example 1-2

FIG. 6 illustrates a configuration example of SSB, SMTC, and MG according to operation example 1-2. The scaling factor P is specified in 3GPP as follows:

$$\text{?} \qquad [ Math . 2 ]$$

$$\text{?} \text{indicates text missing or illegible when filed}$$

Here, in the case of the configuration of SSB, SMTC, and MG illustrated in the above the provision (as illustrated in FIG. 6 as an example), the P_{sharing factor} may always be 1. The mitigated value may be reported as the UE capability information.

### (3.2.3) Operation Example 1-3

p8

FIG. 7 illustrates a configuration example of SSB, SMTC, and MG according to operation example 1-3. The scaling factor P is specified in 3GPP as follows:

$$\text{?} \qquad [ Math . 3 ]$$

$$\text{?} \text{indicates text missing or illegible when filed}$$

Here, it may be the same as the provision in which the SSB is partially overlapped with the MG in FR1. The scaling factor P_{sc} may always be 1. The mitigated value may be reported as the UE capability information.

### (3.2.4) Operation Example 1-4

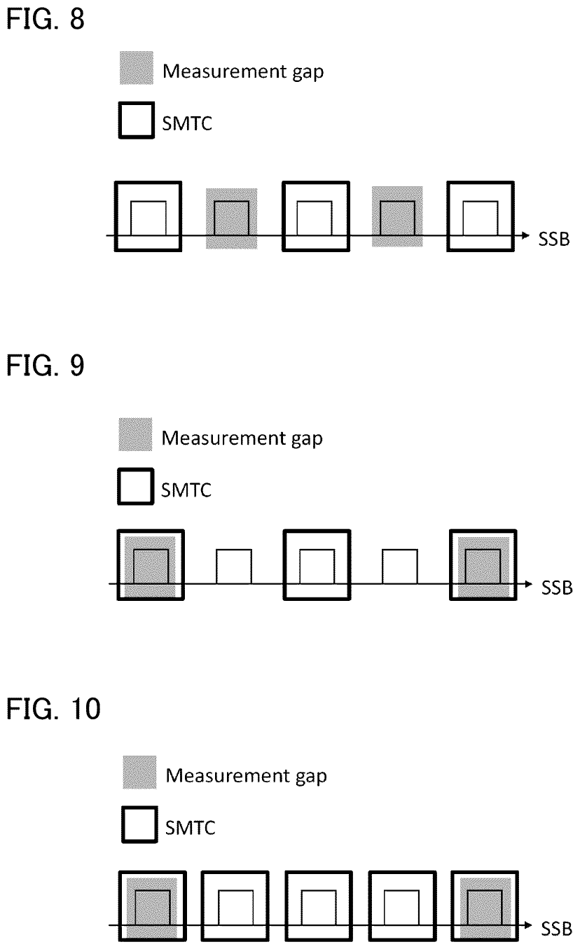

FIG. 8 illustrates a configuration example of SSB, SMTC, and MG according to operation example 1-4. The scaling factor P is specified in 3GPP as follows:

$$\text{?} \qquad [ Math . 4 ]$$

$$\text{?} \text{indicates text missing or illegible when filed}$$

Here, it may be the same as the provision in which the SSB is partially overlapped with the MG in FR1. The P_{sharing factor} may always be 1. The mitigated value may be reported as the UE capability information.

### (3.2.5) Operation Example 1-5

FIG. 9 illustrates a configuration example of SSB, SMTC, and MG according to operation example 1-5. The scaling factor P is specified in 3GPP as follows:

$$\text{?} \qquad [ Math . 5 ]$$

$$\text{?} \text{indicates text missing or illegible when filed}$$

Here, it may be the same as the provision in which the SSB is partially overlapped with the MG in FR1. The scaling factor P_{sc} may always be 1. The mitigated value may be reported as the UE capability Information.

### (3.2.6) Operation Example 1-6

FIG. 10 illustrates a configuration example of SSB, SMTC, and MG according to operation example 1-6. The scaling factor P is specified in 3GPP as follows:

$$\text{?} \qquad [ Math . 6 ]$$

$$\text{?} \text{indicates text missing or illegible when filed}$$

Here, it may be the same as the provision in which the SSB is partially overlapped with the MG in FR1. The P_{sharing factor} may always be 1. The mitigated value may be reported as the UE capability information.

### (3.3) Operation Example 2

Regarding L3 measurement related to L3 measurement delay, the following scaling factors are mainly specified in 3GPP.
N1 at the time of cell reselection
K_{layer1_measurement} at the time of Intra freq. measurement/inter-freq. without gap

N1 is specified in 3GPP TS38.133 Sec 4.2.2.2, and can take a value such as 3, 4, 5, 8 in FR2. Further, K_{layer1_measurement} is specified as follows.

$$\text{?} \qquad [ Math . 7 ]$$

$$\text{?} \text{indicates text missing or illegible when filed}$$

N1 and K_{layer1_measurement} may also become large values because simultaneous measurement cannot be performed in FR2.

Therefore, the UE 200 may mitigate (reduce) the values of N1 and K_{layer1_measurement} by simultaneously receiving beams BMs and the like using multiple Rx chains.

The value of N1 may be specified as a fixed value, or clearly specified in the specification as value corresponding to the number of Rx chains. The value of K_{layer1_measurement} may always be 1. In addition, the configured values of N1 and/or K_{layer1_measurement} may be reported to the network as the UE capability information.

### (3.4) Operation Example 3

Regarding RLM (Radio Link Monitoring) and BFD/CBD requirements, the required measurement time is specified in 3GPP for each of SSB and CSI-RS based.

Regarding FR2, the problem is that a relatively long time is required due to the following factors.
8 samples are required as the number of SSB measurement samples
If SMTC and MG overlap in time, the measurement is required alternatingly

In such a beam fault detection and a subsequent candidate beam detection, the UE 200 may reduce the number of measurement samples by performing simultaneously reception using multiple Rx chains,

The required number of samples may be specified as a fixed value, or clearly specified in the specification as a value corresponding to the number of Rx chains. In addition, the information on the determined (configured) number of samples may be reported to the network as the UE capability information.

The UE 200 may mitigate a value of the scaling factor P by simultaneously receiving beams BMs or the like using multiple Rx chains (same as operation example 1).

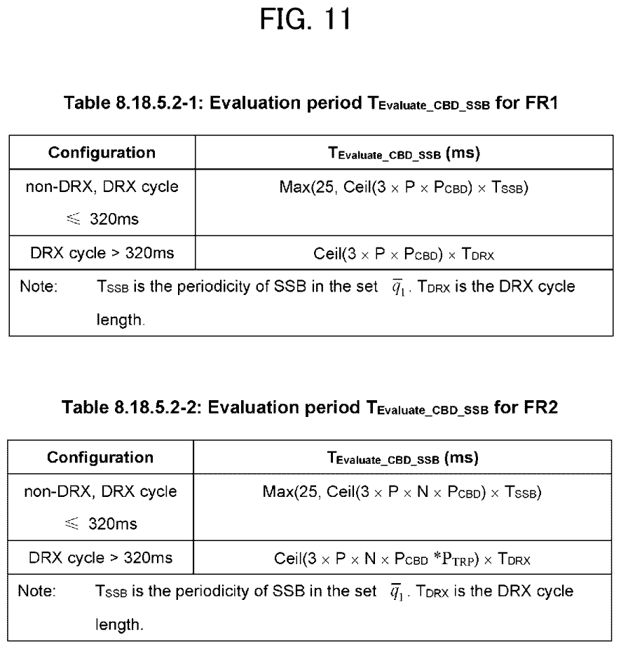

Specifically, the value of the scaling factor P_{TRP} may be mitigated. FIG. 11 illustrates a configuration of an evaluation time (T_{Evaluate_CBD_SSB}/T_{Evaluate_CBD_CSI-RS}) to which a scaling factor PTRP is referred. T_{Evaluate_CBD_SSB}/T_{Evaluate_CBD_CSI-RS} is specified in 3GPP TS38.133 Sec 8.18.5.2 and 8.18.6.2.

Further, the mitigation described above is not limited to a single TRP (transmission/reception point), and may also be applied to BFD/CBD when multiple TRPs are used. In the case of BFD/CBD when multiple TRPs are used, the scaling factor P_{TRP} used when the resources for each TRP overlap may always be 1. The value of the scaling factor P_{TRP} may be reported to the network as the UE capability information.

### (3.5) Operation Example 4

Regarding scheduling/measurement restrictions, as described above, in Release up to 3GPP Release 17, it is assumed that only one beam can be transmitted and received simultaneously. Therefore, there is a problem that multiple signals (data) cannot be transmitted and received simultaneously in time.

RLM, L1-RSRP measurement, L3-measurement, BFD/CBD, and L1-SINR measurement all have similar restrictions.

Therefore, regarding the provision of scheduling/measurement restriction, UE 200 may mitigate the restrictions on UE scheduling and/or measurement by applying the same provision as FR1 (that is, no restriction) by simultaneously receiving beams BMs and the like using multiple Rx chains,

### (3.6) Operation Example 5

Regarding TCI state switching delay with dual TCI, there is no clear provision on how to manage a TCI state on the assumption of simultaneous reception using multiple Rx chains. Therefore, the problem is that the TCI state is managed based on which Rx chain.

For this reason, when managing a TCI state using multiple Rx chains, the provision may be established for each of the following scenarios.

### When Managing a TCI State Commonly Using Multiple Rx Chains:

The SNR measurement method for determining the known condition of the TCI state may be clearly specified, or left to the implementation of UE 200.

### When Managing a TCI State Separately Using Multiple Rx Chains:

The operation according to the existing TCI state switching provision may be performed for each Rx chain, or the operation using an Rx chain with less delay preferentially may be performed.

### (4) Operation and Effect

According to the above embodiment, the following operation and effect can be obtained. Specifically, when receiving an SSB or a CSI-RS using multiple reception chains (Rx chains), the UE 200 may reduce the number of samples used for measurement in FR2 compared to receiving the SSB or the CSI-RS using a single reception chain.

Therefore, various scaling factors applied to FR2 regarding RRM can be mitigated (reduced). Thus, the UE 200 can perform an operation related to a faster measurement even when using a high frequency band such as FR2.

Further, when receiving an SSB or a CSI-RS using multiple reception chains in FR2, the UE 200 may apply a common transmission configuration indication (TCI) to the multiple reception chains. Alternatively, when receiving an SSB or a CSI-RS using multiple reception chains in FR2, the UE 200 may apply an individual TCI to each of the multiple reception chains.

Therefore, the handling of a TCI state when receiving an SSB or a CSI-RS using multiple reception chains is clarified, thereby making it possible for the UE 200 to perform an operation related to RRM stably and reliably even when using multiple reception chains,

### (5) Other Embodiments

Although the embodiment has been described as above, the present disclosure is not limited to the description of the embodiment, and it is obvious to those skilled in the art that various modifications and improvements are possible.

For example, in the embodiment described above, the operation related to a mitigation of various scaling factors applied to FR2 regarding RRM has been described; however, FR2 may be interpreted as either or both of FR2-1 and FR2-2. In addition, a frequency range other than FR2 may be used.

In the above disclosure, terms such as configure, activate, update, indicate, enable, specify, and select may be read interchangeably. Similarly, terms such as link, associate, correspond, and map may be read interchangeably, and terms such as allocate, assign, monitor, and map may be read interchangeably.

In addition, terms such as specific, dedicated, UE-specific, and UE-dedicated may be read interchangeably. Similarly, terms such as common, shared, group-common, UE-common, and UE-shared may be read interchangeably.

In the present disclosure, terms such as “precoding,” “precoder,” “weight,” “quasi-co-location (QCL),” “Transmission Configuration Indication state (TCI state),” “spatial relation,” “spatial domain filter,” “transmit power,” “phase rotation,” “antenna port,” “antenna port group,” “layer,” “number of layers,” “rank,” “resource,” “resource set,” “resource group,” “beam,” “beam width,” “beam angle,” “antenna,” “antenna element,” and “panel” may be used interchangeably.

The block diagram (FIG. 4) used in the description of the above-described embodiment illustrates blocks in units of functions. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a. “transmitting Section (transmitting unit),” a “transmitter,” and the like. The method for implementing each component is not particularly limited as described above.

Further, the above-described gNB 100 and UE 200 (the device) may function as a computer that performs processing of a radio communication method of the present disclosure. FIG. 12 is a diagram illustrating an example of a hardware configuration of the device. As illustrated in FIG. 12, the device may be configured as a computer device including a processor 1001, a memory 1002, a storage 1003, a communication device 1004, an input device 1005, an output device 1006, a bus 1007, and the like.

Furthermore, in the following description, the term “device” can be read as meaning circuit, device, unit, or the like. The hardware configuration of the device may include one or more devices illustrated in the figure or may not include some of the devices.

Each of the functional blocks of the devices (FIG. 4) is implemented by means of any of hardware elements of the computer device or a combination of the hardware elements.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus.” The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on,

The communication apparatus 1004 may be configured to include a high frequency switch, a duplexer, a filter, a frequency synthesizer, and so on in order to realize, for example, at least one of frequency division duplex (FDD) and time division duplex (TDD).

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the device may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware,

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these, According to the above, a case is described in which there is a single network node other than the base station 10. However, a combination of multiple other network nodes may be considered (e.g., MME and S-GW),

Information or signals (information and the like) may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an notification implicit (transmission/reporting) (e.g., by not performing notification (transmission/reporting) of the predetermined information).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like,

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any of a one of various different technologies. For example, data, an instruction, a command, information, a signal, a bit, a symbol, a chip, or the like, described throughout the present application, may be represented by a voltage, an electric current, electromagnetic waves, magnetic fields, magnetic particle, optical fields, a photon, or a combination thereof.

It should be noted that a term used in the present specification and/or term required for understanding of the present specification may be replaced by a term having the same or similar meaning. For example, a channel and a symbol may be a signal (signaling). Further a signal may also be a message. Further, the component carrier (CC) may be referred to as a carrier frequency, cell, frequency carrier, or the like.

As used in the present disclosure, the terms “system” and “network” are used interchangeably.

Furthermore, the information, parameters, and the like, described in the present disclosure may be expressed using absolute values, relative values from a predetermined values, or they may be expressed using corresponding different information. For example, a radio resource may be what is indicated by an index.

The names used for the parameters described above are not used as limitation. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

Furthermore, the base station in the present disclosure may be interpreted as a mobile station (hereinafter, a user terminal), For example, each aspect/embodiment of the present disclosure may be applied to the structure that replaces a communication between a base station and a mobile station with a communication between a plurality of mobile stations (for example, which may be referred to as “Device-to-Device (D2D),” “Vehicle-to-Everything (V2X),” and the like). In this case, mobile stations may have the functions of the base stations described above. The words such as “uplink” and “downlink” may be interpreted as the words corresponding to the terminal-to-terminal communication (for example, “side”). For example, an uplink channel, a downlink channel and so on may be interpreted as a sidelink channel (or sidelink).

Likewise, the mobile station in the present disclosure may be interpreted as base station. In this case, the base station may have the functions of the mobile station described above.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for user terminals, scheduling of allocating radio resources (such as a frequency bandwidth and transmit power available for each user terminal) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms,

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB));” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP,

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

“Means” included in the configuration of each of the above apparatuses may be replaced by “parts”, “circuits”, “devices”, etc.

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way,

In the case where the terms “include”, “including” and variations thereof are used in the present disclosure, these terms are intended to be comprehensive in the same way as the term “comprising”, Further, the term “or” used in the present specification is not intended to be an “exclusive or”.

In the present disclosure, where an article is added by translation, for example “a”, “an”, and “the”, the disclosure may include that the noun following these articles is plural.

As used herein, the term “determining” may encompasses a wide variety of actions. For example, “determining” may be regarded as judging, calculating, computing, processing, deriving, investigating, looking up (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing and the like. That is, “determining” may be regarded as a certain type of action related to determining.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”

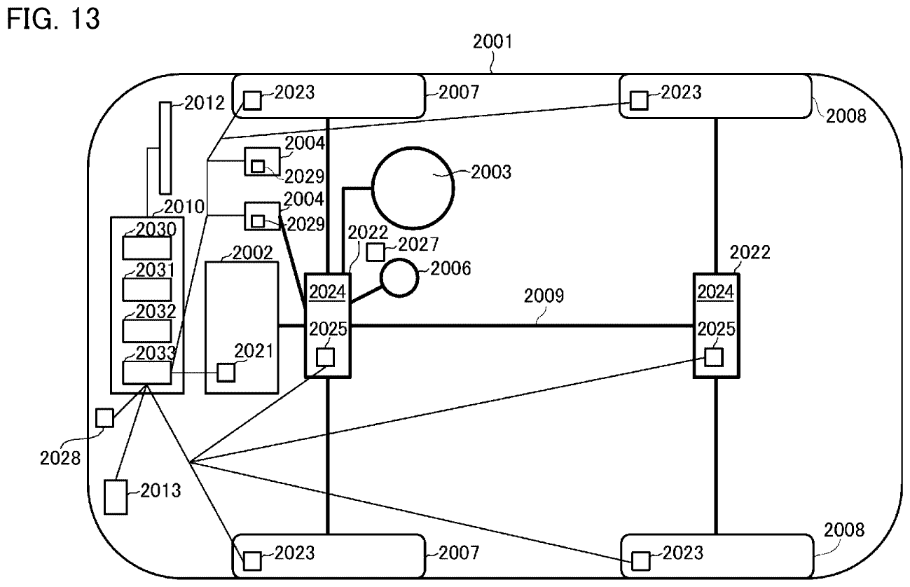

FIG. 13 shows a configuration example of a vehicle 2001. As shown in FIG. 13, the vehicle 2001 includes a drive unit 2002, a steering unit 2003, an accelerator pedal 2004, a brake pedal 2005, a shift lever 2006, left and right front wheels 2007, left and right rear wheels 2008, an axle 2009, an electronic control unit 2010, various sensors 2021 to 2029, an information service unit 2012, and a communication module 2013.

The drive unit 2002 may include, for example, an engine, a motor, and a hybrid of an engine and a motor.

The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2027 provided in the vehicle. The electronic control unit 2010 may be referred to as an ECU (Electronic control unit).

The signals from the various sensors 2021 to 2028 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 1 by using information obtained from the external device through the communication module 2013 or the like.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 1 via a communication port. For example, the communication module 2013 transmits and receives data via a communication port 2033, to and from the drive unit 2002, the steering unit 2003, the accelerator pedal 2004, the brake pedal 2005, the shift lever 2006, the left and right front wheels 2007, the left and right rear wheels 2008, the axle 2009, the microprocessor 2031 and the memory (ROM, RAM) 2032 in the electronic control unit 2010, and sensors 2021 to 2028 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like,

The communication module 2013 transmits a current signal from a current sensor and input to the electronic control unit 2010 to an external device via radio communication. Further, the communication module 2013 transmits a rotation speed signal of a front wheel and a rear wheel acquired by the revolution sensor 2022, a pressure signal of a front wheel and a rear wheel acquired by a pneumatic sensor 2023, a speed signal of a vehicle acquired by a vehicle speed sensor 2024, an acceleration signal acquired by an acceleration sensor 2025, an accelerator pedal pressed-amount signal acquired by an accelerator pedal sensor 2029, a brake pedal pressed-amount signal acquired by a brake pedal sensor 2026, an operation signal of the shift lever acquired by a shift lever sensor 2027, and a detection signal acquired by an object detection sensor 2028 for detecting obstacles, vehicles, pedestrians, and the like input to the electronic control unit 2010 to an external device via radio communication.

The communication module 2013 receives various types of information (traffic information, signal information, inter-vehicle information, etc.) transmitted from the external devices and displays the received information on the information service unit 2012 provided in the vehicle. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the left and right front wheels 2007, the left and right rear wheels 2008, the axle 2009, the sensors 2021-2028, etc., mounted in the vehicle 2001.

### Supplementary Note

The above disclosure may be expressed as follows.

The first feature is a terminal including:
a reception unit that simultaneously receives a synchronization signal block or a reference signal using multiple reception chains; and
a control unit that, when receiving the synchronization signal block or the reference signal using the multiple reception chains in a second frequency range that is a higher frequency band than a first frequency range, reduces the number of samples used for measurement in the second frequency range compared to receiving the synchronization signal block or the reference signal using a single reception chain.

The second feature is that in the first feature, the control unit applies the number of samples specified for the first frequency range.

The third feature is that in the first or the second feature, the control unit applies the number of samples corresponding to the number of reception chains.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
20 NG-RAN
100 gNB
200 UE
210 Radio signal transmission and reception unit
220 Amplifier unit
230 Modulation and demodulation unit
240 Control signal and reference signal processing unit
250 Encoding/decoding unit
260 Data transmission and reception unit
270 Control unit
1001 Processor
1002 Memory
1003 Storage
1004 Communication device
1005 Input device
1006 Output device
1007 Bus
2001 Vehicle
2002 Drive unit
2003 Steering unit
2004 Accelerator pedal
2005 Brake pedal
2006 Shift lever
2007 Left and right front wheels
2008 Left and right rear wheels
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port

1. A terminal comprising:
a reception unit that simultaneously receives a synchronization signal block or a reference signal using multiple reception chains; and
a control unit that, when receiving the synchronization signal block or the reference signal using the multiple reception chains in a second frequency range that is a higher frequency band than a first frequency range, reduces a number of samples used for measurement in the second frequency range compared to receiving the synchronization signal block or the reference signal using a single reception chain.

2. The terminal according to claim 1, wherein
the control unit applies the number of samples specified for the first frequency range.

3. The terminal according to claim 1, wherein
the control unit applies the number of samples corresponding to the number of reception chains.

4. A terminal comprising:
a reception unit that simultaneously receives a synchronization signal block or a reference signal using multiple reception chains; and
a control unit that, when receiving the synchronization signal block or the reference signal using the multiple reception chains in a second frequency range that is a higher frequency band than a first frequency range, applies a common transmission configuration indication to the multiple reception chains.

5. A terminal comprising:
a reception unit that simultaneously receives synchronization signal block or a reference signal using multiple reception chains; and
a control unit that, when receiving the synchronization signal block or the reference signal using the multiple reception chains in a second frequency range that is a higher frequency band than a first frequency range, applies an individual transmission configuration indication to each of the multiple reception chains.

6. A radio communication method comprising:
a step of simultaneously receiving a synchronization signal block or a reference signal using multiple reception chains; and
a step of reducing, when receiving the synchronization signal block or the reference signal using the multiple reception chains in a second frequency range that is a higher frequency band than a first frequency range, a number of samples used for measurement in the second frequency range compared to receiving the synchronization signal block or the reference signal using a single reception chain.
